(19) United States
(12) Patent Application Publication
(10) Pub. No.: US 2019/0156989 A1
(43) Pub. Date: May 23, 2019

(54) ELECTROMAGNETIC INDUCTION DEVICE AND MANUFACTURING METHOD THEREFOR

(71) Applicant: BOLYMEDIA HOLDING CO . LTD., Santa Clara, CA (US)

(72) Inventor: Xiaoping HU, Shenzhen (CN)

(21) Appl. No.: 16/302,047

(22) PCT Filed: May 16, 2016
(86) PCT No.: PCT/CN2016/082167

§ 371 Date: Nov. 15, 2018

(51) Int. Cl. H01F 27/28; H01F 30/06; H01F 27/29; H01F 27/24; H01F 27/02; H01F 41/04

(52) U.S. Cl. CPC H01F 27/2804; H01F 30/06; H01F 27/29; H01F 2027/2809; H01F 27/02; H01F 41/041; H01F 27/24

(57) ABSTRACT

An electromagnetic induction device, comprising a magnetic coating (110) and at least one set of coils (120). The magnetic coating (110) is formed by splicing all magnetic cells together, and is provided therein with at least one cavity. Magnetic division surfaces (AA) between each two magnetic cells are substantially arranged along a magnetic flux loop without cutting off the magnetic flux loop. The coils (120) are placed in a cavity formed by the magnetic coating (110), and the magnetic flux loop in the magnetic coating (110) is formed by the coils (120) after being energized. The overall structure of the magnetic coating (110) comprises at least two magnetically permeable layers (110′, 110″). The electromagnetic induction device, on the one hand, can be substantially closed to reduce leakage flux; on the other hand, since there is no air gap on a magnetic unit, the magnetic reluctance is effectively reduced. In addition, the magnetic coating (110) is of a layered structure so that the electromagnetic induction device can be fabricated in a superposed manner, thereby not only reducing the manufacturing difficulty, but also facilitating obtaining a high-performance flat electromagnetic induction device. Also provided is a corresponding method for manufacturing the electromagnetic induction device.

### TECHNICAL FIELD

The present disclosure relates to electronic or electric devices, and in particular, to electromagnetic induction devices and manufacturing methods thereof.

### BACKGROUND OF THE INVENTION

Generally, weak-current equipment (which operates in lower voltage and lower current) is referred to as an electronic device, while heavy-current equipment (which operates in higher voltage and higher current) is referred to as an electric device. Many electronic and electric devices, such as inductors, transformers and the like, operate based on electromagnetic induction effect.

An electromagnetic induction device may typically include a magnetic core and a coil. A transformer is a common electromagnetic induction device. The structure of a conventional transformer is configured to wrap a magnetic core with coils. Such structure may lead to a large magnetic flux leakage for the transformer, causing energy loss and radiation damage. In order to reduce the magnetic flux leakage, there has been also a shell-type transformer in which the coils are wound by a portion of the magnetic core uncovered by the coils (i.e. magnetic yoke). Such transformer may increase magnetic resistance due to the presence of an air gap in a magnetic flux loop.

Moreover, for the manufacture of a conventional electromagnetic induction device, a wire is wound around a magnetic core which has already been formed integrally so as to form a coil, making the fabrication difficult and the device difficult to miniaturize. Therefore, there is still a need to improve existing electromagnetic induction devices.

### SUMMARY OF THE INVENTION

According to one aspect of the present disclosure, an electromagnetic induction device is provided. The electromagnetic induction device may include a magnetic cover and at least one set of coils. The magnetic cover is consisted of two or more magnetic units, each magnetic unit is able to form a closed magnetic flux loop, and all of the magnetic units are fitted together to form an integrated body having at least one cavity therein. A magnetic dividing surface between the magnetic units is arranged substantially along the magnetic flux loop without interrupting the magnetic flux loop. The coils is arranged in the cavity formed by the magnetic cover, the electrodes of the coils are led out of the magnetic cover, and the magnetic flux loop in the magnetic cover is produced after energization of the coils. The magnetic dividing surface may be formed by an air gap or an insulating material; the overall structure of the magnetic cover may include at least two magnetically permeable layers which are substantially parallel to each other, the magnetically permeable layers may be substantially parallel to the magnetic dividing surface or substantially perpendicular to the magnetic dividing surface; and in a case where the magnetically permeable layers are substantially perpendicular to the magnetic dividing surface, the portion of one magnetic unit respectively arranged at different magnetically permeable layers may be seamlessly joined as a whole by magnetic materials across layers.

According to another aspect of the present disclosure, a method for manufacturing an electromagnetic induction device is provided. The method may include the steps of: determining a structure of the electromagnetic induction device according to the present disclosure, disintegrating the determined structure into a plurality of functional layers which are overlapped and substantially parallel to each other, the functional layers including a magnetically permeable layer and an electrically conductive layer, determining the planar configuration of each functional layer, the magnetically permeable layer including an arrangement for magnetic materials and an arrangement for insulating materials, and the configuration of the electrically conductive layer includes an arrangement for conductive materials and an arrangement for insulating materials, generating a base layer which is a magnetically permeable layer of the magnetic cover, and on the base layer, generating at least one electrically conductive layer and another magnetically permeable layer of the magnetic cover on the basis of the determined planar configuration of each functional layer.

With regard to the electromagnetic induction device according to the present disclosure, wrapping the coils by the magnetic cover composed of a plurality of magnetic units may, on the one hand, substantially enclose the coils to reduce magnetic flux leakage, and on the other hand, since magnetic dividing surfaces between magnetic units are disposed along a magnetic flux loop, no air gap is generated in the magnetic flux loop, thereby effectively decreasing magnetic resistance. Furthermore due to the layered structure of the magnetic cover, the electromagnetic induction device can be manufactured in a superposed manner, thereby not only reducing the manufacturing difficulty, but also facilitating obtaining a high-performance flat electromagnetic induction device. The manufacturing method according to the present disclosure which is similar to the processing method of a semiconductor integrated circuit enables enabling large-scale fabrication of the electromagnetic induction device according to the present disclosure, improving product efficiency and reducing product cost.

The embodiments of the present disclosure will be described in details in following with reference to the drawings.

### BRIEF DESCRIPTION OF THE DRAWINGS

FIG. 1 is a schematic structural diagram of an electromagnetic induction device according to a first embodiment;

FIG. 2 is a schematically structural diagram of two magnetic units in the first embodiment;

FIG. 3 is a schematically structural diagram of two coils in the first embodiment;

FIG. 4 is a planarized diagram showing the five functional layers in the first embodiment;

FIG. 5 is a schematically exploded diagram of the electromagnetic induction device in a second embodiment;

FIG. 6 is a schematically structural diagram of coils winding the magnetic core in the second embodiment; and

FIG. 7 is a schematically exploded diagram of the electromagnetic induction device in a third embodiment.

### DETAILED DESCRIPTION

An electromagnetic induction device in accordance with the present disclosure may include a magnetic cover and at least one set of coils.

The so-called magnetic cover refers to a magnetic material casing wrapped around the outside of the device and composed of two or more magnetic units, wherein all of the magnetic units fit together to form a substantially closed integrated body having at least one cavity therein. Preferably, the magnetic cover may be a substantially closed structure to avoid magnetic leakage as much as possible. The so-called “substantially closed” means that the cavity is closed with respect to the exterior, except for one or more necessary channels (e.g. electrodes of the coils) communicating with the interior and exterior of the cavity, as well as one or more necessary apertures (e.g. an air gap between magnetic units) used for design or processing. In addition, if the magnetic cover is generally flat in shape such that the size of the end portion of the cavity is relatively small (i.e., the exposed portion of the coils is small than the entire coils), the magnetic cover at the end portion of the cavity may be incompletely enclosed, which further reduces the difficulty of fabrication without significantly affecting the performance of the device.

The coils are arranged in the cavity formed by the magnetic cover, and the electrodes of the coils are led out of the magnetic cover. A magnetic flux loop may be produced in the magnetic cover after energization of the coils. The coils may be configured to be one set so that the electromagnetic induction device is formed as an inductor, or the coils may be configured to be two or more sets such that the electromagnetic induction device is formed as a multi-valued inductor, an alternating current transformer with a single-voltage output or a multiple-voltage output.

Each respective magnetic unit may be configured to be blocky, sheet, strip-shaped, or thin-film-shaped, etc.; and a closed magnetic flux loop can be produced within each respective magnetic unit. In other words, the coils may produce a magnetic flux loop on each magnetic unit with substantially no air gap. The so-called “substantially no air gap” means that the magnetic flux occupying a major portion of each respective magnetic unit is able to form a loop without an air gap. Where a small amount of magnetic flux fails to be closed in one magnetic unit due to difference in precision between theoretical design and actual product, process limitation and the like, it should not be considered beyond the scope of the present disclosure.

A magnetic dividing surface between the magnetic units is arranged substantially along the magnetic flux loop without interrupting the magnetic flux loop. The magnetic dividing surface may be specifically formed by an air gap or an insulating material. Generally, the normal of the magnetic dividing surface is substantially parallel to the direction of the current in the coils. According to the present disclosure, the magnetic unit or the magnetic dividing surface may be designed in the following manner: first, determining the structure of an integrated magnetic cover; next, determining the structure of a magnetic flux loop produced within the magnetic cover according to the arrangement of coils, such as winding configuration, placement mode of the coils in the cavity of the magnetic cover, and the like; then, providing magnetic dividing surfaces along the magnetic flux loop to divide the magnetic cover into a plurality of magnetic units, that is, dividing the entire magnetic flux loop into a plurality of mutually non-intersecting portions. The so-called “mutually non-intersecting” includes conditions that the portions are parallel to each other (i.e. portions having an identical path curvature) and that the portions are nesting with each other (i.e. portions with high path curvature are nested in portions with low path curvature).

Therefore, in a preferred embodiment, the magnetic dividing surfaces may include a plane magnetic dividing surface that divides the magnetic flux loop into two or more parallel portions, or a cylinder magnetic dividing surface that divides the magnetic flux loop into two or more portions nested with each other, or a combination thereof. For example, by means of first dividing a magnetic cover into blocks or pieces with plane magnetic dividing surfaces, then further dividing the blocks or pieces into layers with cylinder magnetic dividing surface, a magnetic cover having a configuration of parallel blocks and nested layers may be formed. The shape of the so-called cylinder magnetic dividing surface, which may be for example circular, elliptical, polygonal, or the like, may be determined based on the path curvature and the shape of the magnetic flux loop. The division of the magnetic cover into a plurality of magnetic units can effectively reduce eddy currents, thereby decreasing energy consumption and operating temperature of the devices.

The electromagnetic induction device according to the present disclosure may not contain a magnetic core, that is, no magnetic material is provided inside the coils, and such device is hereinafter referred to as a class I device; and it may also contain a magnetic core, which is hereinafter referred to as a class II device. For the class II device, as a preferred embodiment, the magnetic core may also be divided into more than two portions in a manner similar to the division of the magnetic cover so as to reduce eddy currents. The magnetic core can be either a separate component from the magnetic cover or it can be formed integrally with the magnetic cover in the light of concrete device structure.

The magnetic cover, the magnetic core and the coils in the present disclosure have been described above in accordance with the configuration of magnetic flux loop and current circuit. The overall structure of each functional component will be illustrated below.

In the electromagnetic induction device according to the present disclosure, at least the overall structure of the magnetic cover is layered; in other words, the overall structure of the magnetic cover may include at least two magnetically permeable layers which are substantially parallel. The magnetically permeable layers may be basically parallel to the magnetic dividing surface or substantially perpendicular to the magnetic dividing surface. In the case where the magnetically permeable layers are substantially parallel to the magnetic dividing surface, one magnetic unit may be completely in one magnetically permeable layer, so an air gap between adjacent magnetically permeable layers or an insulating layer formed of an insulating material can be regarded as a magnetic dividing surface. In the case where the magnetically permeable layers are substantially perpendicular to the magnetic dividing surface, portions of one magnetic unit which are respectively located at different magnetic permeable layers may be seamlessly joined as a whole by the magnetic material across the layers, thereby forming a magnetic unit substantially free of air gaps. For the class II device, the magnetic core integrally may similarly have a layered structure, which is for example formed to be one or more magnetically permeable layers.

As a preferred embodiment, the overall structure of the coils may also be layered. In other words, the overall structure of the coils may include at least one electrically conductive layer which is substantially parallel to the magnetically permeable layer of the magnetic cover; and the conductive lines located in one same electrically conductive layer may be insulated from each other. For the class I device, the coils may be implemented by one or more laminated electrically conductive layers due to no magnetic core. For the class II device, the coils may be realized by at least two electrically conductive layers up and down to avoid the difficulty of winding, and the magnetic core is located between the two electrically conductive layers. Where more than two electrically conductive layers are included, portions of a set of coils which are respectively disposed at different electrically conductive layers may be joined as a whole by the conductive lines across the layers. An insulating layer formed of an insulating material is required to be provided between two adjacent electrically conductive layers so as to separate them; and the magnetically permeable layer and its adjacent electrically conductive layer, or two adjacent magnetically permeable layers, may be directly superposed, or be separate only by an air gap, or be provided with a corresponding insulating layer, which can be determined according to the insulation property of the magnetic material used and the safety requirement for voltage between lines.

Where an insulating material is used to form as the magnetic dividing surface or the insulating layer, an insulating material having good thermal conductivity is preferably employed, so that the insulating structure can also be served as a heat dissipating structure, effectively reducing the temperature of the device.

The thickness of the magnetically permeable layers, the electrically conductive layer, the insulating layer or the like in the electromagnetic induction device according to the present disclosure is easily made much smaller than its planar size, such as length or width, so that the electromagnetic induction device according to the present disclosure has a flat appearance, for example, the overall thickness of the device is less than 10% of its length or width. In such case, the volume of the coils exposed at the end of the cavity is small and the leakage flux generated is also little, so a closed magnetic cover may not be formed at the exposed end of the cavity where the manufacturing is inconvenient.

The magnetic cover or the magnetic units are made of magnetic materials and may be electrically conductive, preferably non-conductive. For example, the materials may be selected from a group consisting of: ferroferric oxide and mixtures thereof (e.g. cobalt-doped ferroferric oxide), chromium dioxide, ferric oxide and mixtures thereof, carbon-based ferromagnetic powder, resin carbon-based ferromagnetic powder, permalloy powder, Fe—Si—Al powder, Fe—Ni powder, ferrites, silicon steel, amorphous and nanocrystalline alloys, Fe-based amorphous alloys, iron-nickel base, Fe—Ni based-amorphous alloy, nanocrystalline alloy, supermalloy, and the like.

The coils may be made of a wire covered with an insulating layer, and the wire may be made of conductive material including copper, aluminum, magnesium, gold, silver, and an alloy material for conducting electricity.

In a preferred embodiment, a separator made of an insulating material may be arranged at the magnetic dividing surface, such as a spacer, a diaphragm, or an insulating varnish layer, to maintain separation of the magnetic units and reduce eddy currents.

Specific applications of the electromagnetic induction device according to the present disclosure will be exemplified below, and the above description of the overall concept may be applied to the following embodiments.

### First Embodiment

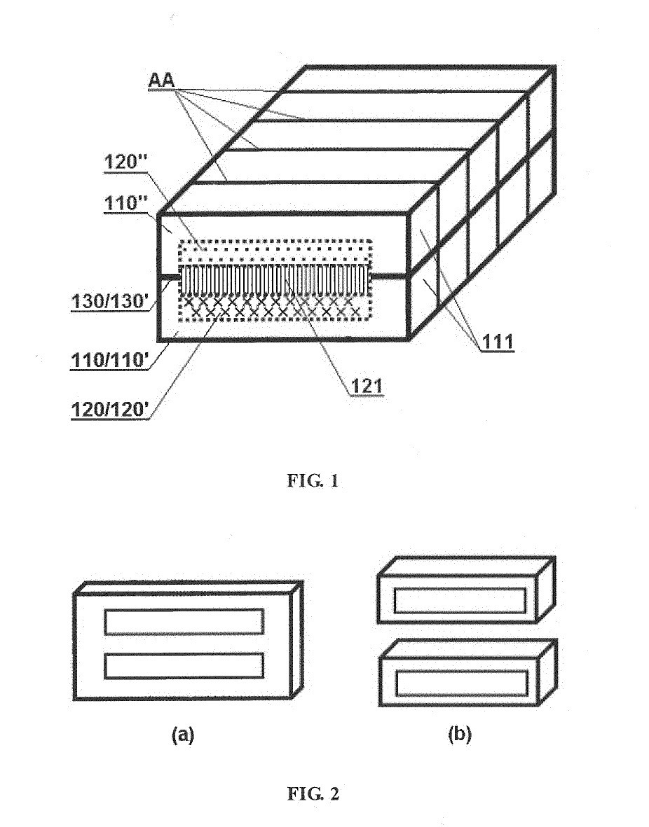

FIGS. 1 to 4 show an embodiment of electromagnetic induction device in accordance with the present disclosure. The electromagnetic induction device is a class II device and may include a magnetic cover 110, coils 120 and a magnetic core 130.

The overall structure of the device in this embodiment may include five functional layers from bottom to top successively: a first magnetic permeable layer 110′ serving as the bottom of the magnetic cover, a first electrically conductive layer 120′ serving as the lower half of the coils, a second magnetically permeable layer 130′ serving as the magnetic core, a second electrically conductive layer 120″ serving as the upper half of the coils, and a third magnetically permeable layer 110″ serving as the top of the magnetic cover. The magnetic core in this embodiment can be considered as a part of the magnetic cover.

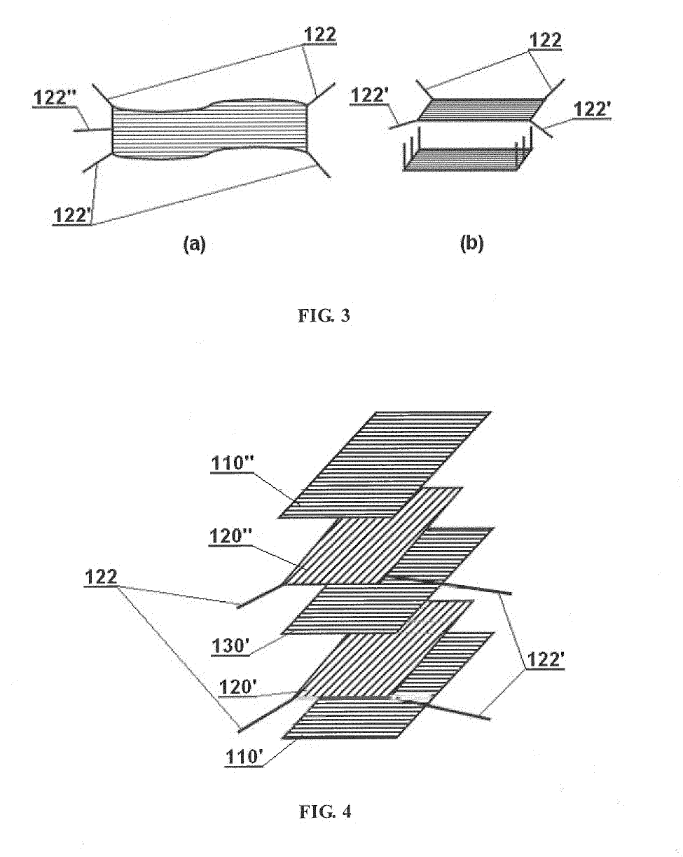

There may be two kinds of structures to be employed when setting the magnetic dividing surface. In one kind of the structures, as shown in FIG. 2(a), one magnetic unit has portions located in the three magnetically permeable layers and the portions are seamlessly joined as a whole by the magnetic material 111 at the edges of the magnetically permeable layers; in this case the magnetic dividing surface is substantially perpendicular to the magnetically permeable layers. Another kind of the structures, as shown in FIG. 2(b), differs from FIG. 2(a) in that, besides the dividing surface perpendicular to the magnetically permeable layers, it further has a magnetic dividing surface which is parallel to the magnetically permeable layers to further divide the magnetic unit shown in the FIG. 2(a) into upper and lower parts; in this case, it can be considered that the magnetic core is composed of two overlapping magnetically permeable layers, the magnetic dividing surface parallel to the magnetically permeable layer can be regarded as the air gap or the insulating layer between the two magnetically permeable layers of the magnetic core, and each magnetically permeable layer of the magnetic core can respectively be seamlessly connected with the corresponding top or bottom magnetically permeable layer at the edge position.

The coils are formed by two electrically conductive layers respectively located on the upper and lower sides of the magnetic core, and the two electrically conductive layers are integrally connected by the conductive lines 121 at the ends to form the coils. In this embodiment, there are two sets of coils, one set is led out to the outside of the magnetic cover by a pair of electrode leads 122, and the other set is taken out to the outside of the magnetic cover by a pair of electrode leads 122′. The two electrically conductive layers of the coils can be produced by two kinds of structures. One structure shown in FIG. 3(a) is generated by surrounding a magnetic core with a piece of flexible printed circuit board (FPCB), and is welded at the ends into a ring shape. Another one shown in FIG. 3(b) adopts two pieces of printed circuit boards (PCBs) as the electrically conductive layers respectively, and uses wires connected at both ends of the electrically conductive layers respectively to form the coils. Of course, more electrode leads may be provided in the electrically conductive layers as needed, such as 122″ shown in FIG. 3(a), and a desired circuit structure can be obtained by externally connecting the leads in series or in parallel as needed. It should be noted that one piece of FPCB or PCB used may be multi-layered, that is, one piece thereof may contain a multi-layer circuit structure. An electrically conductive layer may have multiple pieces of FPCBs or PCBs.

It is well known that electrons mainly flow on the surface of a conductor. Therefore, using a thin layer of electrically conductive layer to form the coils not only makes the gap between the coils and the magnetic cover or the magnetic core extremely tiny, but also maximizes the use of conductive material, which is advantageous for reducing copper loss, reducing cost, and reducing volume. In this embodiment, FPCB or PCB is also used to fabricate the coils of the electromagnetic induction device, avoiding the difficulty in winding, mounting, and wiring connecting simultaneously and guaranteeing the quality of the coils (such as insulation and consistency).

The cavity inside the magnetic cover is an annular one 112, and its overall shape may be doughnut-shaped, elliptical ring-shaped, rectangular, polygonal and the like. The normal section of the hollow portion of the cavity may be rectangular or round, or a relatively random shape as long as the coils can be wrapped therein. Preferably, the cavity should wrap the coils as closely as possible, and its shape can therefore substantially conform to the shape of the cross section of the coils.

Preferably, the insulating material forming the magnetic dividing surface may be made of heat conductive material; and since the magnetic dividing surface is perpendicular to and in contact with the electrically conductive layer, the insulating material may also serve as heat sinks for the coils. This not only helps to increase the power density of the electromagnetic induction device, but also can be used to monitor the temperature of the internal coils, providing safety.

For better appreciating the layered structure of the electromagnetic induction device of the present embodiment, the five functional layers thereof are further shown in FIG. 4 in a planarized form. In FIG. 4, the white bands in the magnetically permeable layers 110′, 130′, 110″ may represent areas of magnetic material, and the black bands spaced apart in the white bands may represent areas of insulating material; the white bands in the electrically conductive layers 120′, 120″ may indicate areas of conductive material, and the black bands spaced in the white bands may indicate areas of insulating material. The five functional layers may be formed successively from bottom to top, wherein the band structures of the three magnetically permeable layers may be identical, and the band structure of the two electrically conductive layers may be different, and it is noted that they may be connected at the corresponding ends to form required coils. When using the planar manufacturing fabrication, the edges of each magnetically permeable layer should be aligned in accordance with the divided magnetic units and be seamlessly connected by using a magnetically permeable material, and the conductive lines in the electrically conductive layers should also be aligned at the ends and joined into coils.

It is obvious that the structure of each layer in FIG. 4 can be easily replicated on a same plane along the horizontal or vertical direction, thereby making it possible to mass-produce an electromagnetic induction device in a large scale, which is similar to the integrated processing method of semiconductor chips. After the large-scale planar manufacturing fabrication is completed, a large amount of devices having similar structures can be obtained by cutting; and then connecting the edge portions may be performed. On the other hand, by such planar manufacturing fabrication, the electromagnetic induction device can be arranged together with other electronic devices or circuit structures which can be manufactured in a layered manner, thus improving the integration and reliability of the entire circuit.

In addition, it may be also possible to continue superimposing a laminated electromagnetic induction device on another one to generate another electromagnetic induction device, and the two overlapping electromagnetic induction devices can be separated by an insulating layer (especially a thermally conductive insulating layer). This not only improves production efficiency, but also facilitates high-power electromagnetic induction devices by simple series or parallel connection of external lines.

It can be seen that under this very compact laminate structure, the magnetically conductive layers at the bottom and top layers form an almost closed and tightly packed cavity; even though the ends of the two electrically conductive layers (where conductive connections are crossing layers) not covered by the magnetic cover is only a very narrow area, which hardly affects the overall performance of the device.

### Second Embodiment

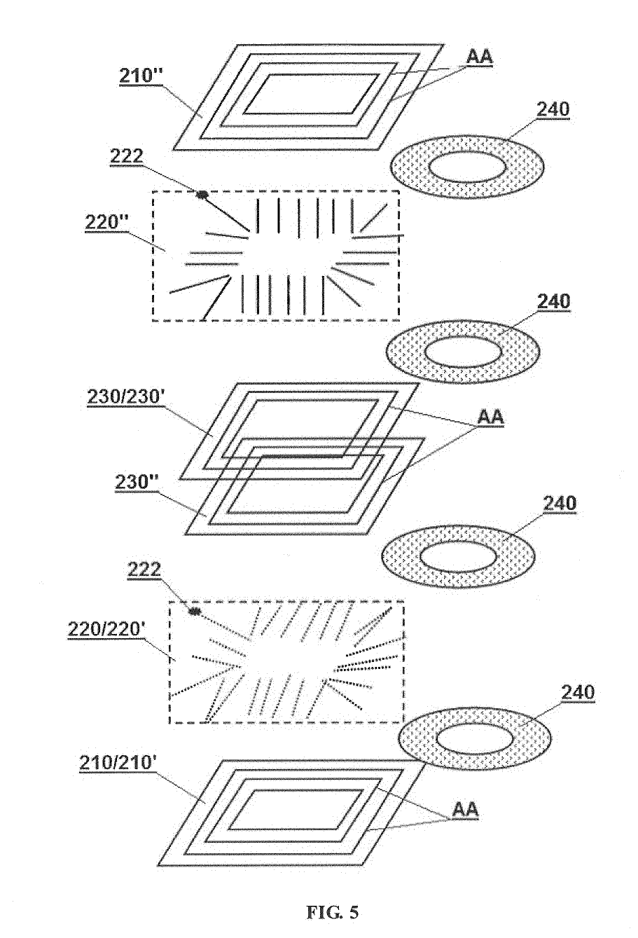

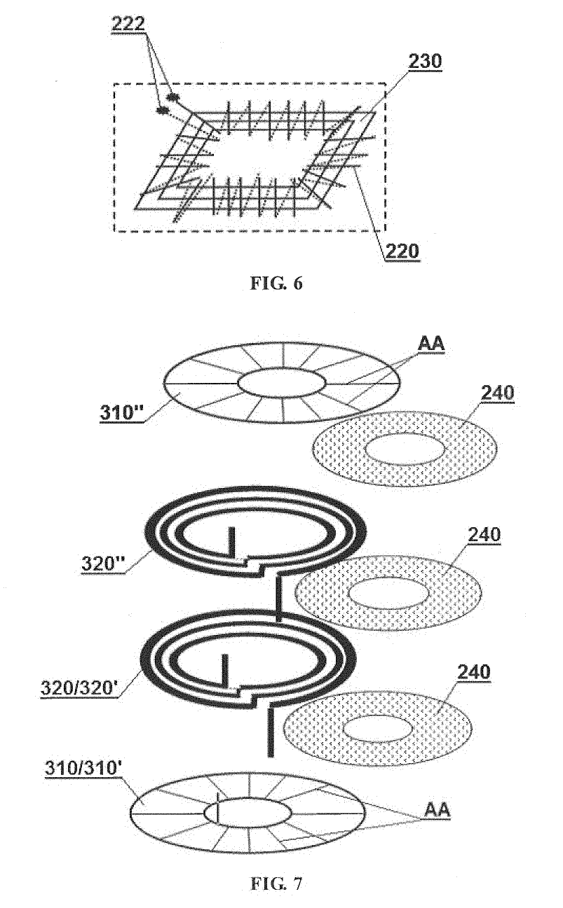

FIG. 5 and FIG. 6 show another embodiment of electromagnetic induction device in accordance with the present disclosure. The electromagnetic induction device is a class II device and may include a magnetic cover 210, coils 220 and a magnetic core 230.

The structure of this embodiment is similar to that of the first embodiment. The overall structure may include five functional layers from bottom to top successively: a first magnetic permeable layer 210′ serving as the bottom of the magnetic cover, a first electrically conductive layer 220′ serving as the lower half of the coils (the conductive lines are indicated by dotted lines), a second magnetically permeable layer 230′ serving as the magnetic core, a second electrically conductive layer 220″ serving as the upper half of the coils (the conductive lines are indicated by solid lines), and a third magnetically permeable layer 210″ serving as the top of the magnetic cover. The magnetic core and the magnetic cover in this embodiment each have an independent magnetic flux loop. In the figures, the plane in which the conductive layer is located is shown in dashed lines, and for the sake of simplicity, only one set of coils is shown, which is drawn through a pair of electrodes 222. If multiple sets of coils are needed, corresponding lines and electrode leads can be added to the two conductive layers, which will not be described again. In the present embodiment, an insulating layer 240 (especially a thermally conductive insulating layer) may also be provided between adjacent different types of functional layers to enhance the anti-pressure capability and heat dissipation of the device.

A main difference between this embodiment and the first embodiment is that the way in which the coils are wound around the core is different. In this embodiment, the cavity inside the magnetic cover is an annular cavity, the coils are formed by wires winding around its axis, the axis of the coils may be extended in a direction substantially conforming to the extending direction of the annular cavity, and the annular magnetic core is packaged inside the coils. Therefore, the magnetic dividing surface AA in the present embodiment may be a plane magnetic dividing surface substantially parallel to the annulus of the annular cavity, or it may be a cylinder magnetic dividing surface coaxial with the annulus of the annular cavity.

Compared with the first embodiment, in a case where the coil volumes are the same, the number of coil turns in this embodiment is much larger than that of the coil turns in the first embodiment, and thus it is more suitable for fabricating a high-voltage electromagnetic induction device or an inductance having a high inductance value.

It is to be noted that, since the magnetic flux in the magnetic core is relatively large, it is preferable to add one (or more) magnetically permeable layer 230″ to overlap with the magnetically permeable layer 230′ to function as a magnetic core.

All the individual functional layers in the present disclosure may be implemented by two or more functional layers of the same kind; for the magnetically permeable layers, this means that the structure of the magnetic flux loop allows a magnetic dividing surface parallel to the magnetically permeable layer so as to divide a single magnetically permeable layer into two or more overlapping magnetically permeable layers; for the electrically conductive layers, a single conductive layer or a plurality of overlapping conductive layers may be used to meet actual needs in design, as long as the conductive lines can be connected as needed. In view of this, in the present disclosure, it is general to use only a single functional layer for describing the structure, but in practice, it should be understood that two or more overlapping functional layers of the same kind are included.

### Third Embodiment

FIG. 7 shows still another embodiment of electromagnetic induction device in accordance with the present disclosure. The electromagnetic induction device is a class I device and may include a magnetic cover 310 and coils 320.

This embodiment which is a simple implementation of the present disclosure does not have a magnetic core, so the coils can be realized by a single electrically conductive layer, and the overall structure herein may include three functional layers, from bottom to top successively: a first magnetic permeable layer 310′ serving as the bottom of the magnetic cover, a first electrically conductive layer 320′ serving as the coils, and a third magnetically permeable layer 310″ serving as the top of the magnetic cover.

For easy to set multiple sets of coils or to increase the number of coil turns, it is preferable to add an electrically conductive layer 320″ to overlap with the first electrically conductive layer 320′. Of course, more electrically conductive layers may be further overlapped, which will not be described herein again. An insulating layer 240 (especially a thermally conductive insulating layer) is required to provide between adjacent electrically conductive layers. Optionally, an insulating layer 240 may further be provided between adjacent functional layers of different types to improve device performance and enhance reliability.

In this embodiment, the coils are winding around an annular cavity formed by the magnetic cover, and the extending direction of the wires is substantially the same as the extending direction of the annular cavity. Therefore, the magnet dividing surface AA in this embodiment can be a plane magnetic dividing surface which is substantially perpendicular to the extending direction of the wires. Each magnetic unit is divided into two parts, which are respectively arranged at the first magnetically permeable layer 310′ and the second magnetically permeable layer 310″, so that it is needed to align the two magnetically permeable layers up and down, and a magnetic material is used on the inner side and the outer side of the annular cavity for seamless connection, for example, the part of the upper and lower layers to be joined is filled or bonded with a powdery or viscous magnetic material during the manufacturing process to form a complete magnetic unit.

A method for manufacturing the electromagnetic induction device according to the present disclosure in a layered manner, also referred to as a planar manufacturing method, will now be described below. The method, which is used to manufacture the electromagnetic induction device according to the present disclosure in a way similar to the processing method of a semiconductor integrated circuit, may specifically include the following steps:

S1. determining the structure of the electromagnetic induction device according to the present disclosure to be fabricated. For example, the structure having five functional layers or three functional layers described in the foregoing various embodiments or similar embodiments. The functional layers include a magnetically permeable layer and an electrically conductive layer. The overall shape of the device, the number of coil sets, the number of coil turns of each set, and the winding manner of the coils can be determined depending on the needs of the actual application to further determine the way of dividing the magnetic unit and the like.

S2. determining the planar configuration of each functional layer, including whether a single functional layer needs to be implemented by two or more functional layers of the same type. The configuration of the magnetically permeable layer may include an arrangement for magnetic materials and an arrangement for insulating materials (or air gaps), and the configuration of the electrically conductive layer may include an arrangement for conductive materials and an arrangement for insulating materials.

Various templates can be created for subsequent processing depending on the determined configuration of each layer, such as photoetch templates magnetic circuit processing, circuit processing, and insulated wire/layer processing. Such step is similar to the one in which the entire electromagnetic induction device is divided into pieces. For ease of manufacturing, when performing disintegrating into layers, it is preferred that the planar configuration of each layer may be achieved by a consistent process, such as coating, etching, and the like.

S3. optionally, reproducing the design structures and templates required for each layer in a horizontal or vertical direction on a larger area to realize large-scale production, so that each layer produced can correspond to a corresponding layer of multiple electromagnetic induction devices.

S4. generating a base layer which is a magnetically permeable layer of the magnetic cover. Since the entire device is packaged by a magnetic cover, the magnetically permeable layer as part of the magnetic cover may need to be made firstly.

S5. on the base layer, generating at least one electrically conductive layer and another magnetically permeable layer of the magnetic cover on the basis of the determined planar configuration of each functional layer. For example, when fabricating a triple-layer device, an electrically conductive layer and a magnetically permeable layer are alternately formed on the base layer, and when manufacturing a five-layer device, an electrically conductive layer, a magnetically permeable layer (acting as the magnetic core), an electrically conductive layer and a magnetically permeable layer are alternately formed on the base layer. Optionally, an insulating layer can be produced between two functional layers.

A specific producing way can be determined according to actual needs and process capability, for example, it may include spraying, sputtering, coating, chemical precipitation, etc., which may refer to the process of a semiconductor integrated circuit.

S6. optionally, further performing a cross-layer connection during or after the planar manufacturing fabrication, which may include:

in a case where it is required to form a magnetic unit across layers, the portions belonging to the same magnetic unit respectively located in different magnetically permeable layers are seamlessly connected by a magnetic material across layers, for example connecting at the edges of the magnetically permeable layers, or

in a case where it is desired to form windings across layers, the portions belonging to the same set of the coils respectively located in different electrically conductive layers are integrally connected by conductive lines across layers, for example connecting at the ends of the electrically conductive layers.

S7. optionally, repeating the above steps to continue to fabricate a new electromagnetic induction device on an electromagnetic induction device that has been manufactured with planar manufacturing so as to obtain an overlapping electromagnetic induction device. Before manufacturing the new electromagnetic induction device, an insulating layer (especially a thermally conductive insulating layer) may be provided on the functional layer (magnetically permeable layer) on the top of the fabricated electromagnetic induction device for separation.

As an example, an instance for the above manufacturing method is:

1. on the basis of the planar structure of the magnetically permeable layer as the bottom of the magnetic cover, spraying to generate a portion of the magnetic unit on the plane, i.e. planar regions formed of magnetic materials and separated by insulating separating lines, to be used as the base layer;

2. spraying to generate an insulating layer on the present layer;

(step 1 and step 2 can be repeated to generate a plurality of overlapping magnetically permeable layers)

3. spraying to generate planar regions formed of electrically conductive materials (each region may serve as a wire) on the basis of the coil configuration designed on the next electrically conductive layer to make an electrically conductive layer;

(step 2 and step 3 can be repeated to generate a plurality of overlapped electrically conductive layers)

4. spraying to generate an insulating layer on the present layer;

5. on the basis of the planar structure of the next magnetically permeable layer, spraying to generate a portion of the magnetic unit on the plane; for a three-layer device, this layer is served as the magnetically permeable layer on the top of the magnetic cover; and for a five-layer device, this layer is served as the magnetically permeable layer of the magnetic core;

(step 4 and step 5 can be repeated to generate a plurality of overlapped magnetically permeable layers)

(for a five-layer device, if three layers have been generated, steps 2 to 5 will be repeated, and when step 5 is performed at a second time, it means that the magnetically permeable layer as the top of the magnetic cover is producing)

6. repeating steps 1 to 5 when a new and overlapping electromagnetic induction device is needed until the overlapping electromagnetic induction devices having a required number are formed.

This preferred manufacturing method has the same advantages as the processing for the semiconductor integrated circuit, by replicating each layer of the electromagnetic induction device to be processed, multiple devices can be processed simultaneously, thereby greatly improving production efficiency and reducing production costs. Moreover, the manufacturing method of the electromagnetic induction device of the present disclosure can also be integrated into the process of making a semiconductor chip, thereby generating a semiconductor chip having a built-in electromagnetic induction device, which opens up a new idea for the design of the semiconductor chip.

The electromagnetic induction device according to the present disclosure has advantages of low loss, high energy density, low electromagnetic interference, and the like, and can be integrated not only with a low-power semiconductor device but also with a high-power semiconductor device.

The principle and embodiments of the present disclosure are described wither reference to the specific examples hereinabove. It should be understood that the embodiments above are merely used to facilitate understanding the present disclosure, but should not be interpreted as limitations to the present disclosure. For a person ordinarily skilled in the art, variations to the specific embodiments above may be made according to the concept of the present disclosure.

1. An electromagnetic induction device, comprising:
a magnetic cover consisting of two or more magnetic units, each magnetic unit being able to form a closed magnetic flux loop, all of the magnetic units fitting together to form an integrated body having at least one cavity therein, and a magnetic dividing surface between the magnetic units being arranged substantially along the magnetic flux loop without interrupting the magnetic flux loop; and
at least one set of coils arranged in the cavity formed by the magnetic cover, the electrodes of the coils being led out of the magnetic cover, and a magnetic flux loop in the magnetic cover being produced after energization of the coils.
wherein the magnetic dividing surface is formed by an air gap or an insulating material; the overall structure of the magnetic cover includes at least two magnetically permeable layers which are substantially parallel to each other, the magnetically permeable layers are substantially parallel to the magnetic dividing surface or substantially perpendicular to the magnetic dividing surface; and in a case where the magnetically permeable layers are substantially perpendicular to the magnetic dividing surface, the portion of one magnetic unit respectively arranged at different magnetically permeable layers is seamlessly joined as a whole by magnetic materials across layers.

2. The electromagnetic induction device according to claim 1, wherein
the overall structure of the coils includes at least one electrically conductive layer which is substantially parallel to the magnetically permeable layer of the magnetic cover; the conductive lines arranged in one same electrically conductive layer are insulated from each other; and in a case where more than two electrically conductive layers are included, portions of a set of coils which are respectively disposed at different electrically conductive layers may be joined as a whole by the conductive lines across the layers.

3. The electromagnetic induction device according to claim 2, wherein
an insulating layer formed by an insulating material is further provided between the magnetically permeable layer and adjacent electrically conductive layer, or between two adjacent magnetically permeable layers or between two adjacent electrically conductive layers.

4. The electromagnetic induction device according to claim 1, wherein
the magnetically permeable surface includes a plane magnetic dividing surface that divides the magnetic flux loop into two or more parallel portions, or a cylinder magnetic dividing surface that divides the magnetic flux loop into two or more portions nested with each other.

5. The electromagnetic induction device according to claim 1, wherein
the cavity inside the magnetic cover is an annular cavity, the magnetic cover is divided into two or more magnetic units by a magnetic dividing surface which is substantially parallel to the annulus of the annular cavity,
the coils are formed by wires winding around its axis, and the axis of the coils is extended in a direction substantially conforming to the extending direction of the annular cavity.

6. The electromagnetic induction device according to claim 5, further comprising
an annular magnetic core wrapped inside the coils, wherein the overall structure of the magnetic core includes at least one magnetically permeable layer substantially parallel to the annulus of the annular cavity, and in a case where the magnetic core has two or more magnetically permeable layers, two adjacent magnetically permeable layers of the magnetic core are separated by an air gap or an insulating material.

7. The electromagnetic induction device according to claim 6, wherein
the annular structure of the magnetic core arranged in one magnetically permeable layer is divided into two or more nested portions by an annulus coaxial therewith.

8. The electromagnetic induction device according to claim 5, wherein
the magnetic cover is further divided into nested magnetic units by a cylinder magnetic dividing surface coaxial with the annulus of the annular cavity.

9. The electromagnetic induction device according to claim 1, further comprising one or more of the following features:
the material used for making the magnetic units being selected from a group consisting of: ferroferric oxide and mixtures thereof, chromium dioxide, ferric oxide and mixtures thereof, carbon-based ferromagnetic powder, resin carbon-based ferromagnetic powder, permalloy powder, Fe—Si—Al⁻ powder, Fe—Ni powder, ferrites, silicon steel, amorphous and nanocrystalline alloys, Fe-based amorphous alloys, iron-nickel base, Fe—Ni based-amorphous alloy, nanocrystalline alloy, and supermalloy.

10. The electromagnetic induction device according to claim 1, wherein
the coils are configured to be one set so that the electromagnetic induction device is formed as an inductor, or
the coils are configured to be two or three or more sets such that the electromagnetic induction device is formed as a multi-valued inductor, an alternating current transformer with a single voltage output or a multiple-voltage output.

11. A method for manufacturing the electromagnetic induction device, comprising:
determining a structure of the electromagnetic induction device according to claim 1,
disintegrating the determined structure into a plurality of functional layers which are overlapped and substantially parallel to each other, the functional layers including a magnetically permeable layer and an electrically conductive layer, determining the planar configuration of each functional layer, the magnetically permeable layer including an arrangement for magnetic materials and an arrangement for insulating materials, and the configuration of the electrically conductive layer includes an arrangement for conductive materials and an arrangement for insulating materials,
generating a base layer which is a magnetically permeable layer of the magnetic cover, and
on the base layer, generating at least one electrically conductive layer and another magnetically permeable layer of the magnetic cover on the basis of the determined planar configuration of each functional layer.

12. The manufacturing method according to claim 11, further comprising
generating at least one magnetically permeable layer serving as the magnetic core between two electrically conductive layers, or
generating an insulating layer between two functional layers.

13. The manufacturing method according to claim 11, further comprising
in a case where it is required to form a magnetic unit across layers, the portions belonging to the same magnetic unit respectively located in different magnetically permeable layers are seamlessly connected by a magnetic material across layers, or
in a case where it is desired to form windings across layers, the portions belonging to the same set of the coils respectively located in different electrically conductive layers are integrally connected by conductive lines across layers.
